(19) United States
(12) Patent Application Publication
(10) Pub. No.: US 2002/0019745 A1
(43) Pub. Date: Feb. 14, 2002

(54) Method for providing data-processing service

(76) Inventors: Yoshitoshi Yamagiwa, Nagano (JP); Hoshina Masatake, Nagano (JP); Masashi Suganuma, Nagano (JP)

Correspondence Address: BIRCH STEWART KOLASCH & BIRCH, PO BOX 747, FALLS CHURCH, VA, 22040-0747, US

(21) Appl. No.: 09/925,466

(22) Filed: Aug. 10, 2001

(30) Foreign Application Priority Data
Aug. 11, 2000 (JP) 2000-245246

(51) Int. Cl. G06F 17/60

(52) U.S. Cl. 705/1

(57) ABSTRACT

A method for providing data-processing service. When primary data (e.g., three-dimensional CAD data regarding product design) are uploaded via the Internet from a client computer to a server computer of an application service provider, the primary data are processed by use of an application program provided in the server computer, whereby a service for converting the primary data to secondary data (e.g., three-dimensional CAD data for mold design) is provided.

### BACKGROUND OF THE INVENTION

1. Field of the Invention:

The present invention relates to a method for providing data-processing service by use of the Internet.

2. Description of the Relevant Art:

Generally, a product manufacturer which uses plastic components in its products frequently consigns production of plastic components to an outside molding company. In such a case, in the product manufacturer, a product is typically designed by use of a CAD/CAM system, and data regarding product design are provided, as they are, to the molding company. Since various types of products, including electronic products, automobiles, and articles for daily use, are manufactured, various types of software programs for product design have been provided, each being suitable for designing a certain type of product. Examples of known software programs for such purpose include “Pro/ENGINEER” (registered trademark), “I-DEAS” (registered trademark), and “CATIA” (registered trademark).

Meanwhile, in the molding company, a mold for producing products must be prepared in advance, and the mold is typically designed by use of a CAD/CAM system dedicated for mold design, such as, for example, a three-dimensional CAD apparatus disclosed in Japanese Patent Application Laid-Open (kokai) No. 9(1997)-231410 and a mold-design assisting system disclosed in Japanese Patent Application Laid-Open (kokai) No. 10(1998)-86199. Moreover, for mold design as well, software programs dedicated for mold design are used in many cases. Examples of known software programs for such purpose include “CAM-TOOL. C3” (registered trademark) and “CADCEUS” (registered trademark).

Since data regarding product design closely resemble data regarding mold design, it would be convenient for the CAD/CAM system in the molding company to use data regarding a product designed by use of a certain software program for product design. However, in general, data regarding a product designed by use of a certain software program for product design cannot be used in a software program for mold design which employs a different data format. In view of this, conversion software programs have been provided.

However, such conversion software programs designed for use with three-dimensional CAD data are considerably expensive. Further, various types of product design software programs are available, and the number of the types will possibly increase in the future. Therefore, a molding company (mold production company) must make a heavy outlay if the molding company is to cope with such a trend. In addition, quickly designing molds properly becomes difficult.

### SUMMARY OF THE INVENTION

An object of the present invention is to provide a data-processing-service providing method which eliminates necessity of expensive software, which a user would otherwise have to purchase, and which greatly reduces costs involved in mold design, etc.

Another object of the present invention is to provide a data-processing-service providing method which enables quick and proper mold design.

In order to achieve the above objects, the present invention provides an improved method for providing data-processing service. When primary data are uploaded via the Internet from a client computer to a server computer of an application service provider, the primary data are processed by use of an application program provided in the server computer, whereby a service for converting the primary data to secondary data is provided.

### BRIEF DESCRIPTION OF THE DRAWINGS

FIG. 1 is a flowchart showing the overall processing steps of a data-processing-service providing method according to an embodiment of the present invention;

FIG. 2 is a flowchart showing the processing steps of the upload processing of the data-processing-service providing method;

FIG. 3 is a flowchart showing the processing steps of the data conversion processing of the data-processing-service providing method;

FIG. 4 is a flowchart showing the processing steps of the download pre-processing of the data-processing-service providing method;

FIG. 5 is a diagram of an embodied system which can perform the data-processing-service providing method;

FIG. 6 is a diagram showing a specific format of a completion mail used in the data-processing-service providing method; and

FIG. 7 is a diagram of a system which can perform the data-processing-service providing method.

### DETAILED DESCRIPTION OF THE PREFERRED EMBODIMENT

An embodiment of the present invention will next be described in detail with reference to the drawings. The accompanying drawings are illustrative of the embodiment and are not meant to limit the scope of the invention. In order to describe the invention clearly, detailed description of known features is omitted.

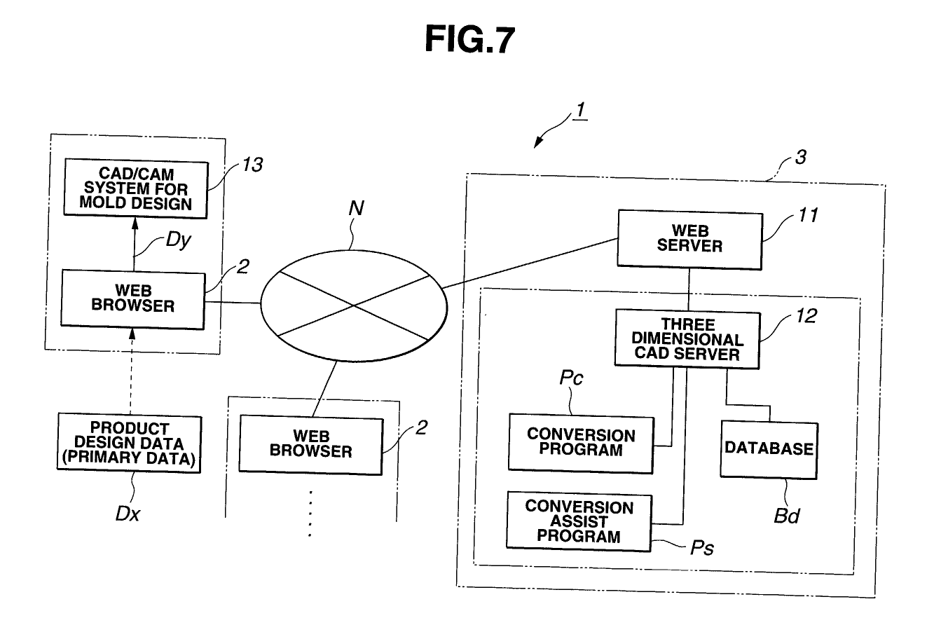

First, the overall configuration of a system which can perform the data-processing-service providing method according to the present embodiment will be described with reference to FIG. 7.

In the system 1 shown in FIG. 7, a server computer 3 includes a Web server (first computing unit) 11 and a three-dimensional CAD server (second computing unit) 12, which are connected with each other. The three-dimensional CAD server 12 has a function for performing data conversion (data processing) by use of a conversion program Pc and a conversion assist program Ps and has a database Bd for registering (storing) various types of data. The conversion program Pc is application software for directly converting primary data Dx; i.e., data regarding a product designed by use of a software program for product design such as “Pro/ENGINEER,” “I-DEAS,” or “CATIA” to secondary data Dy; i.e., data for mold design which can be used by a software program for mold design such as “CAM-TOOL. C3” or “CADCEUS.” The conversion assist program Ps is original application software for performing various types of auxiliary processing in relation to the data conversion (data processing).

The Web server 11 is connected to the Internet N. The Web server 11 can be accessed from any of Web browsers (client computers) 2. The Web browsers 2 are owned by clients (users) Hu who use the processing service according to the present embodiment. Accordingly, any user Hu (molding company (mold production company)) can upload from the corresponding Web browser 2 to the Web server 11 primary data Dx which have been provided from a product manufacture and obtained through designing by use of “Pro/ENGINEER,” “IDEAS,” “CATIA,” or a like software program. Further, the user Hu can download from the Web server 11 to the corresponding Web browser 2 secondary data Dy obtained through data conversion. The thus-downloaded secondary data Dy can be transferred to a CAD/CAM system 13 dedicated for mold design in which “CAM-TOOL. C3,” “CADCEUS,” or a like software program has been installed.

A server computer provided at an application service provider (ASP) is used as the server computer 3. The ASP reefers to a commercial enterprise which provides application outsourcing services by use of the Internet.

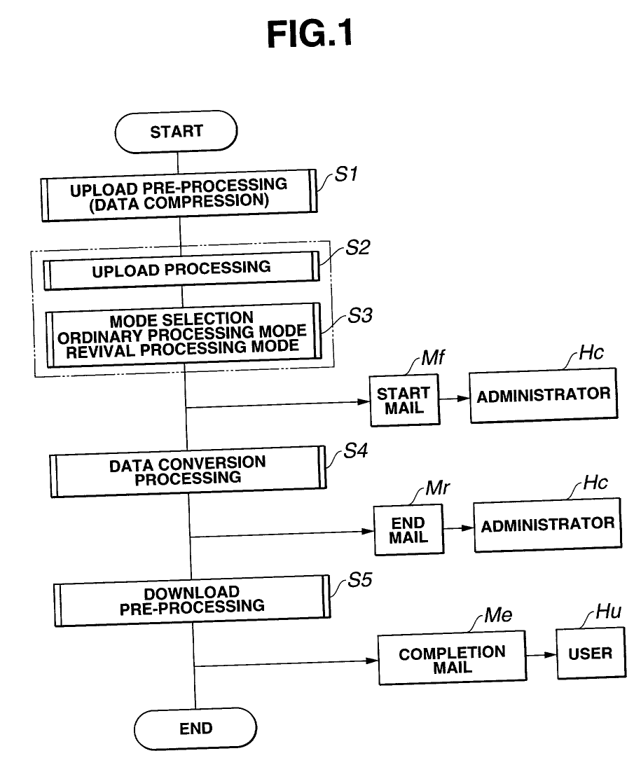

Next, the data-processing-service providing method according to the present embodiment will be described with reference to FIGS. 1 to 6.

First, the outline of the data-processing-service providing method will be described with reference to the flowchart shown in FIG. 1.

Here, we assume that a product manufacturer provides a user Hu (molding company (mold production company)) with primary data Dx regarding a product designed by use of “Pro/ENGINEER,” “I-DEAS,” “CATIA,” or a like software program.

First, the user Hc performs data pre-processing for the primary data Dx (step S1). That is, the user Hc causes the Web browser (client computer) 2 to read the primary data Dx and compress the primary data Dx. The data compression can be performed in accordance with, for example, a well-known LHA scheme. Notably, such data compression is not essential; the primary data Dx may be used as they are without compression. After completion of the data compression, the compressed primary data Dx are stored in the Web browser 2 in the form of a data file.

Subsequently, upload processing is performed (step S2). By means of the upload processing, the data file stored in the Web browser 2 is uploaded to the Web server 11. For the upload processing, a processing mode can be selected or switched between an ordinary processing mode and a revival processing mode (step S3). The ordinary processing mode and the revival processing mode will be described later.

Upon completion of the upload processing, the server computer 3 performs data conversion processing for converting the primary data Dx to the secondary data Dy (step S4). When the data conversion processing is performed, mails (electronic mails) are sent to an administrator Hc who administrates the server computer 3. Specifically, a start mail Mf indicating start of the conversion processing is transmitted to the administrator Hc. In this case, the start mail Mf is transmitted to a mailer (a personal computer, cellular phone, or any other device having a mailer function) designated by the administrator Hc. When the data conversion processing is ended, an end mail Mr indicating end of the conversion processing is transmitted to the administrator Hc.

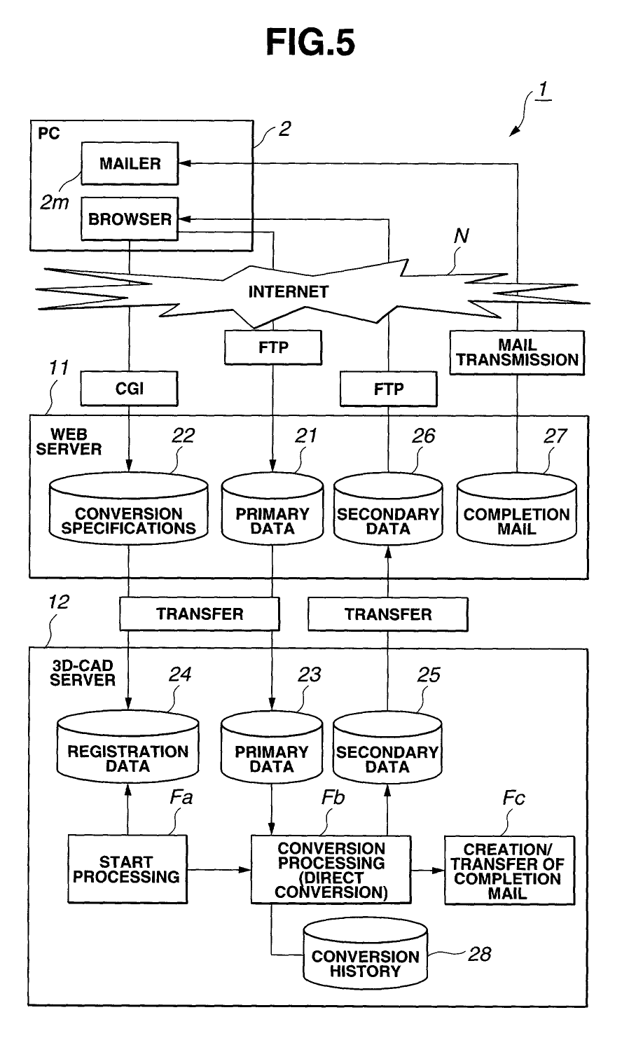

When the data conversion processing is ended, download pre-processing is performed (step S5). Specifically, the secondary data Dy obtained as a result of the data conversion processing are stored in the Web server 11 in order to enable the user Hu to freely download the secondary data Dy through access from the Web browser 2 to the Web server 11. When all of the necessary processing on the administrator Hc side is completed, a completion mail (electronic mail) Me is transmitted to the user Hu. In this case, the completion mail Me is transmitted to a mailer; e.g., a mailer 2m provided in the Web browser 2 (see FIG. 5), designated by the user Hu. The completion mail Me is prepared to include a service use fee and a message indicating completion of data conversion processing, which will be described in detail later.

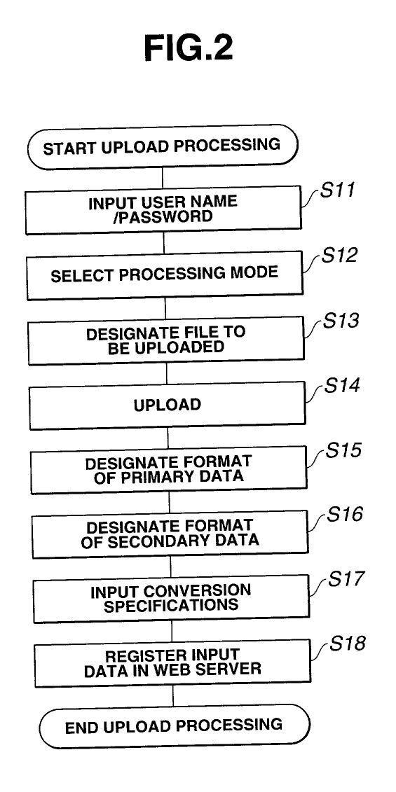

Next, the detailed processing at each step will be described specifically with reference to FIGS. 2 to 5.

FIG. 2 is a flowchart showing the processing steps of the upload processing. When upload is to be performed, the Web browser 2 is connected to the Web server 11 via the internet N. Thus, the top page of a Web site in the Web server 11 is displayed on the display of the Web browser 2. The user Hu performs necessary operations in accordance with a guide of the Web site. First, the user Hu inputs a user name and a password from a user authentication screen (step S11). Notably, the user name and the password are assigned to the user Hu in advance through member registration. After completion of the user authentication, a processing mode selection screen is displayed. The user selects the ordinary processing mode or the revival processing mode (step S12).

The ordinary processing mode is selected when the service is to be used for a new data set. The revival processing mode is selected when primary data Dx uploaded in the past are to be used again. When primary data Dx are uploaded with the ordinary processing mode selected, the server computer 3 stores the primary data Dx for the purpose of backup. That is, the server computer 3 stores the primary data Dx in the form of a backup file to thereby enable performance of re-conversion processing by use of the backup file. Specifically, the backup file is stored in the server computer 3 for a predetermined period (e.g., 10 days). Therefore, the user Hu can use the backup file in the event the user Hu accidentally erases secondary data obtained from the primary data, or when the file contains a plurality of sets of primary data Dx, a set or sets of primary data Dx have not been designated or selected in the previous processing performed in the ordinary processing mode, and the user Hu wishes to convert the remaining set or sets of primary data Dx. Thus, the easiness of use and convenience are enhanced. In the revival processing mode, a new primary data set is not uploaded. Therefore, the user Hu selects and designates a data set to be subjected to re-conversion processing, from the list of data sets (job list) on a revival processing job screen displayed on the display.

By contrast, in the ordinary processing mode, an upload screen is displayed on the display. On the upload screen, the user Hu designates an upload file; i.e., the primary data Dx which has been compressed by means of the data preprocessing at the above-described step S1 (FIG. 1) and stored in the form of a data file (step S13). When the user Hu clicks an upload start key, the designated file is uploaded to the Web server 11 (step S14). The thus-uploaded primary data Dx are temporarily stored in a primary data file region 21 shown in FIG. 5. Notably, any of various upload schemes may be used. For example, the primary data Dx can be uploaded directly by use of an FTP protocol. In this case, the upload processing is performed separately from the procedure on the browser, starting from the above-described user authentication screen.

Upon completion of the upload, a screen for designating the format of primary data is displayed. The user Hu designates the data format of the primary data Dx (step S15). Specifically, the user Hu selects “Pro/ENGINEER,” “I-DEAS,” “CATIA,” or the like from the displayed list. Subsequently, a screen for designating the format of secondary data is displayed. The user Hu designates the data format of the secondary data Dy (step S16). Specifically, the user Hu selects “CAM-TOOL. C3,” “CADCEUS,” or the like from the displayed list. Further, a screen for registering conversion specifications is displayed. The user Hu registers conversion specifications (step S17). The conversion specifications are data which are optionally input in accordance with the data format of the primary data Dx. For example, a conversion scheme is selected between a “scheme of converting all figures while ignoring a current filter” and a “scheme of converting only figures which belong to a current filter,” or a default value of tolerance is designated within a range of “0.1 to 0.0001.” As shown in FIG. 5, such conversion specifications are temporarily registered, as registration data, in a conversion-specification registration file region 22 of the Web server 11 by means of a CGI program (step S18). Thus, the upload to the Web server 11 is completed.

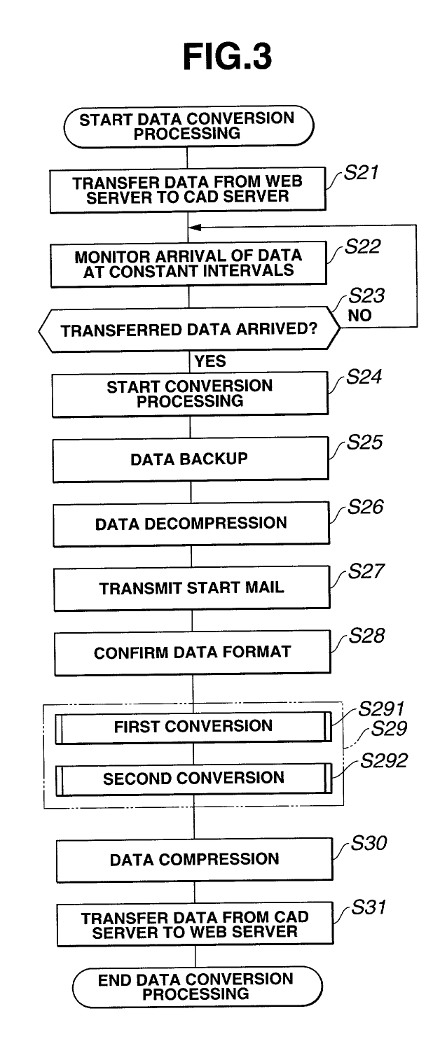

Next, the data conversion processing at the server computer 3 will be described with reference to the flowchart shown in FIG. 3.

Simultaneously with completion of the upload processing; i.e., completion of registration of the conversion specifications, in the server computer 3, the registration data and the primary data Dx stored in the Web server 11 are transferred to a registration-data file region 24 and a primary-data file region 23, respectively, of the three-dimensional CAD server 12, which are shown in FIG. 5 (step S21). In the three-dimensional CAD server 12, a start processing function Fa (FIG. 5) monitors arrival of the primary data Dx and the registration data at constant time intervals (step S22). When the arrival is detected, data conversion processing is started (steps S23 and S24). Upon start of the data conversion processing, processing for backup of the primary data Dx (step S25), processing for data decompression (step S26), and processing for transmitting a start mail Mf to the administrator Hc (step S27) are performed.

Further, the data format is confirmed. When confirmation can be performed successively, direct conversion processing (conversion function Fb) is executed by means of the conversion program Pc (steps S28 and S29). The direct conversion processing includes first conversion processing (step S291) for converting the primary data Dx to standard data (intermediate data), and second conversion processing (step S292) for converting the standard data to the secondary data Dy, which are data to be obtained. The details of the conversion processing vary depending on the conversion scheme of the conversion program Pc used in the embodiment. The present invention can be applied to cases where other conversion schemes are employed, in particular to the case in which data conversion is effected in a single step.

Before performance of the data conversion processing, the start mail Mf is transmitted to a mailer designated by the administrator Hc. The start mail Mf may contain various types of information, such as user name, conversion start time, job number, conversion mode, format of primary data, format of secondary data, and volume of primary data. Secondary data Dy obtained as a result of conversion are stored temporarily in a secondary-data file region 25 shown in FIG. 5 and are compressed by data compression processing (step S30). The thus-compressed secondary data Dy are transmitted from the three-dimensional CAD server 12 to a user-dedicated file region 26 of the Web server 11 (step S31).

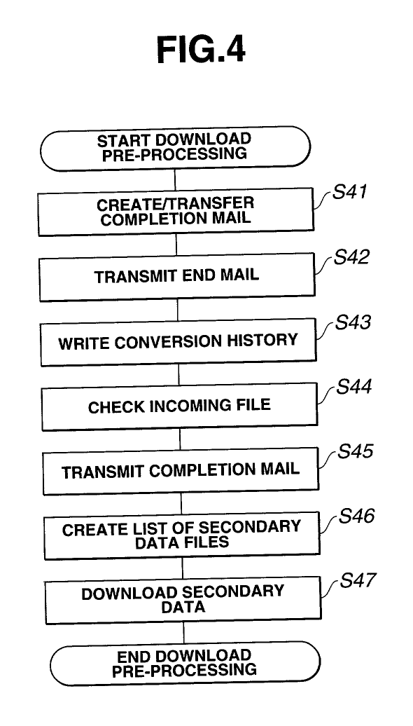

Next, the download pre-processing will be described with reference to the flowchart shown in FIG. 4. The download pre-processing refers to processing for enabling the Web browser 2 to download the secondary data Dy after completion of the data conversion processing.

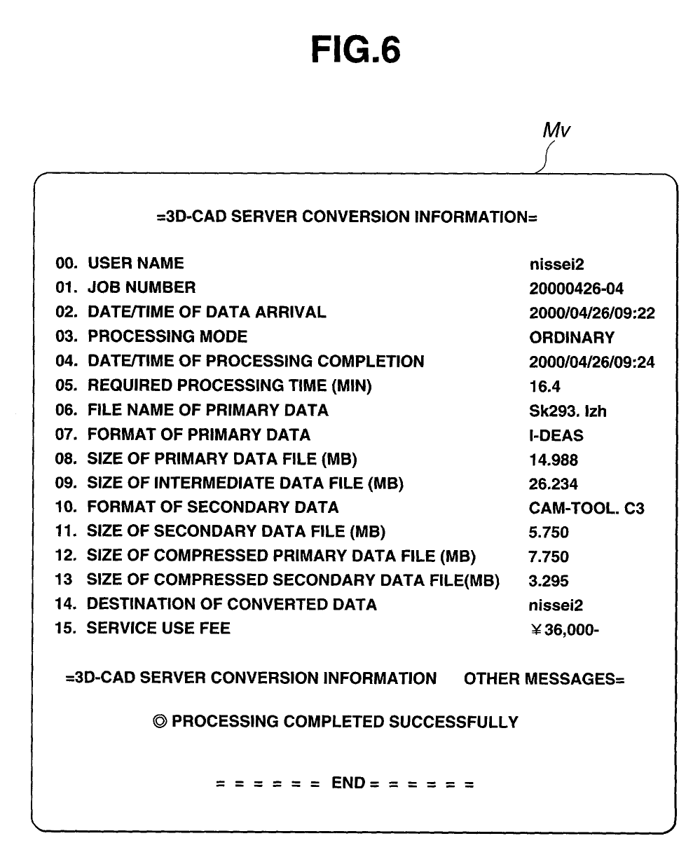

Upon completion of the data conversion processing, a completion mail creation function Fc shown in FIG. 5 creates and transfers a completion mail Me (step S41). Specifically, a conversion status is recorded in a mail file; and a completion mail Me is created and then transferred to a mail file region 27 of the Web server 11. FIG. 6 shows an example screen which displays the completion mail Me. The completion mail Me includes various types of information from which the user Hu can become aware of the result of conversion. Specifically, as shown in FIG. 6, in addition to a message indicating that processing has been completed successfully, the completion mail Me includes user name, job number, date and time of data arrival, processing mode, date and time of processing completion, required processing time, file name of primary data, format of primary data, size of primary data file, size of intermediate data file, format of secondary data, size of secondary data file, size of compressed primary data file, size of compressed secondary data file, destination of converted data, and service use fee. Further, other necessary messages may be included in the completion mail Me. The service use fee may be set in accordance with the volume of converted (file size) or use time.

Further, an end mail Mr is transmitted to the administrator Hc (step S42). The end mail Mr is transmitted to a mailer designated by the administrator Hc, after completion of the data conversion processing. The end mail Mr may contain various types of information, such as user name, conversion end time, job number, data volume after conversion, and status. By virtue of the above configuration, even when the system on the server computer 3 side is automated for manpower-free operation, the administrator Hc can monitor processing status at an arbitrary location. Therefore, in a case in which the administrator Hc does not receive the end mail Mr even after a relatively long period of time has elapsed, the administrator Hc can become aware of the possibility of occurrence of an anomalous state and can take necessary measures.

Meanwhile, upon completion of the data conversion processing, a conversion history is recorded in a log file 28 shown in FIG. 5 (step S43). Further, at constant time intervals the Web server 11 checks whether the completion mail Me has been transferred to the user-dedicated file region 27 (step S44). When the Web server 11 confirms that the completion mail Me has been transferred as a new mail, the Web server 11 transmits the completion mail Me to a mailer 2m (the Web browser 2 in usual cases) designated by the user Hu as shown in FIG. 5 (step S45). Further, in order to allow the user Hu to download, through an interactive operation, the secondary data Dy transferred to the user-dedicated file region 26 shown in FIG. 5, a list of secondary data sets is prepared in HTML format. As will be described later, the list is displayed as a part of a download screen when the user Hu accesses the Web server 11 from the Web browser 2. In order to display the list in HTML format, an HTML file is created by means of the CGI program (step S46).

Thus, through the completion mail Me, the user Hu can become aware of completion of the conversion processing. Therefore, after reception of the completion mail Me, the user Hu accesses the Web server 11 from the Web browser 2 and requests the Web server 11 to download the secondary data Dy. As a result, a download screen containing the above-described list is displayed on the Web browser 2. Subsequently, the user Hu selects the desired secondary data Dy from the list to thereby download the secondary data Dy (step S47).

The data-processing-service providing method according to the present embodiment provides the following advantageous effects. Even when primary data Dx regarding products designed by use of various software programs for product design are provided from, for example, product manufacturers to a user Hu (molding company (or mold production company)), the user Hu is not required to purchase expensive conversion software programs and can reduce greatly the cost involved in designing of molds. In addition, the user Hu can design molds properly and quickly.

Moreover, when primary data Dx are uploaded to the server computer 3, a backup file containing the primary data Dx is stored. Therefore, re-conversion processing can be performed by use of the backup file in the revival processing mode. Therefore, the user Hu can use the backup file effectively when the user Hu accidentally erases secondary data obtained from the primary data, or when the file contains a plurality of sets of primary data Dx, a set or sets of primary data Dx have not been designated or selected in the previous processing performed in the ordinary processing mode, and the user Hu wishes to convert the remaining set or sets of primary data Dx. Thus, the easiness of use and convenience are enhanced.

Meanwhile, when primary data Dx are converted to secondary data Dy, a start mail Mf reporting start of the conversion processing and/or an end mail Mr reporting end of the conversion processing is transmitted to a mailer of the administrator Hc, who manages the server computer 3. Therefore, on the administrator Hc (service provider) side, automation for manpower-free operation is realized, and inexpensive, reliable services can be provided.

While the present invention has been described with reference to the preferred embodiment, the present invention is not limited thereto. Regarding structural details, technique, values, among others, modifications and any omission or addition may be possible as needed without departing from the scope of the invention. For example, in the above embodiment, the server computer 3 stores secondary data Dy in a condition which permits the user to download the data from the client computer 2. However, the embodiment may be modified in such a manner that secondary data Dy are transferred directly to a designated terminal, such as the client computer 2. The above embodiment exemplifies data processing for converting primary data Dx to secondary data Dy having a different data format. However, data processing is not limited thereto. Moreover, in the above embodiment, conversion of three-dimensional CAD data is described as an example data conversion. However, the present invention can also be applied not only to two-dimensional CAD data, and ordinary design data (i.e., other than CAD data), but also to various other types of data regarding documents, translation, charging, etc. In addition, in place of electronic mails, various other types of information transmission means may be used in order to transmit messages to the administrator and users, including transmission of messages to cellular phones by means of voice (synthesized voice). Notably, the term “data for mold design” is a broad term encompassing data used for mold machining and data used for mold production.

What is claimed is:

1. A method for providing data-processing service, wherein when primary data are uploaded via the Internet from a client computer to a server computer of an application service provider, the primary data are subjected to data processing performed by use of an application program provided in the server computer, whereby a service for converting the primary data to secondary data is provided.

2. A method for providing data-processing service according to claim 1, wherein the sever computer stores the secondary data in a state that enables the secondary data to be downloaded to the client computer.

3. A method for providing data-processing service according to claim 1, wherein the data processing is conversion processing for converting the primary data to secondary data having a data format different from that of the primary data.

4. A method for providing data-processing service according to claim 3, wherein the primary data are three-dimensional CAD data.

5. A method for providing data-processing service according to claim 4, wherein the primary data are three-dimensional CAD data regarding product design.

6. A method for providing data-processing service according to claim 3, wherein the secondary data are three-dimensional CAD data.

7. A method for providing data-processing service according to claim 6, wherein the secondary data are three-dimensional CAD data for mold design.

8. A method for providing data-processing service according to claim 3, wherein when the primary data are uploaded to the server computer, a backup file containing the primary data is stored so as to enable re-conversion processing to be performed by use of the backup file in a revival processing mode.

9. A method for providing data-processing service according to claim 3, wherein when the primary data are converted to the secondary data, a start mail indicating start of the conversion processing is transmitted to a mailer of an administrator who administrates the server computer.

10. A method for providing data-processing service according to claim 3, wherein when the primary data are converted to the secondary data, an end mail indicating end of the conversion processing is transmitted to a mailer of an administrator who administrates the server computer.

11. A method for providing data-processing service according to claim 3, wherein when the primary data are converted to the secondary data, a completion mail indicating completion of the conversion processing is transmitted to a mailer of a user.
